(19) United States
(12) Patent Application Publication
(10) Pub. No.: US 2014/0329018 A1
(43) Pub. Date: Nov. 6, 2014

(54) RETICULATED OPEN-CELL FOAM MODIFIED BY FIBERS EXTENDING ACROSS AND BETWEEN THE CELLS OF SAID FOAM AND PREPARATION METHODS THEREOF

(71) Applicant: Peter G. Berrang, Saanichton (CA)

(72) Inventor: Peter G. Berrang, Saanichton (CA)

(21) Appl. No.: 14/233,349

(22) PCT Filed: Jul. 19, 2011
(86) PCT No.: PCT/CA2011/000834

§ 371 Date: Jan. 16, 2014

(51) Int. Cl. C08J 9/00; C23C 18/32

(52) U.S. Cl. CPC C08J 9/0085; C23C 18/32; C08J 2205/05
USPC 427/380; 428/221; 521/52

(57) ABSTRACT

A reticulated foam structure comprising a plurality of closely-spaced fibers extending across and between the cells. A reticulated polymer foam structure is enhanced by fibers of metal, metal alloys, metal oxides, carbon or glass that are chopped or milled and introduced into the foam structure during foam formation or by entrainment of fibers into the foam. The resulting structure is used as a template to create a high porosity reticulated foam structure of a non-polymer material by coating the non-polymer onto the fiber-enhanced structure and removing the polymer by heating or pyrolizing. The design has utility for applications such as filtration, implants, heat transfer and electrodes, which require structures with low cost, high porosity, small effective pore sizes and large contact surface area.

### FIELD OF THE INVENTION

The invention involves reticulated foam structures comprised of polymer, metal, metal alloys, metal oxides, carbon and glass, and the method for making such structures.

### BACKGROUND OF THE INVENTION

Reticulated (or “open-cell”) foam is used in a variety of applications, including non-conductive applications such as filters, heat dissipation, rigid mechanical structures and catalysts, and conductive applications such as electrodes.

Reticulated foam can be polymer-based or made of other materials such as carbon allotropes, metals, metal alloys, metal oxides and glass. Polymer-based reticulated foams can be made from polypropylene, polyurethane, polyethylene, polyester, polyether, acrylonitrile butadiene styrene, fluropolymers, polyvinyl chloride, cellulose, latex, etc., including co-polymers, such as ethylene vinyl acetate

Reticulated polymer foams can also be used as templates to create foams made of other materials. For example, Inco Limited, Toronto, Canada, uses reticulated polyurethane foam as a template to make high purity nickel foam (see Vladimir Paserin, Sam Marcuson, Jun Shu and David S. Wilkinson, Advanced Engineering Materials, 2004, 6, No. 6, 454459, DOI: 10,1002/adem.200405142) as disclosed in U.S. Pat. No. 4,957,543. The nickel foam is produced in large quantity by decomposing nickel carbonyl gas and depositing the nickel onto an open-cell polyurethane foam substrate. The primary application for this material is for battery electrodes, especially for nickel metal hydride batteries. U.S. Pat. No. 5,296,261 teaches a method for making nickel, copper or lead tarn using a reticulated polymer foam (i.e. polyurethane, polyester or polyether) as a template, where the template is impregnated with a nitrate or sulphate solution of nickel, copper or lead. The impregnated foam construct is subsequently heated to burn off the polymer template.

The use of a polymer as the base material for the template foam is attractive as polymers are low cost and widely available in a variety of open cell sizes and porosities. Prior art foamed materials consisting of non-polymer foam templates such as for example carbon or aluminum generally have limitations due to the high cost of producing such materials in commercial quantities, or having relatively small pore sizes between connecting cells, thereby creating high back-pressures for fluids flowing through such materials to create the intended final product.

Techniques such as melt processing, powder processing and vapour deposition for making foamed materials have been developed over past decades (see L. J. Gibson, “Mechanical Behavior of Metallic Foams”, Annu, Rev. Mater. Sci. 2000, 30:191-227) resulting in many commercial enterprises producing a variety of foamed materials.

“Metal Foams: A Design Guide” by M. F. Ashby, A. G. Evans, N. A. Fleck, L. J. Gibson, J. W. Hutchinson and H. N. G. Wadley, published in 2000 by Elsevier, provides a detailed description of various techniques for forming metal foams.

ERG Materials and Aerospace Corporation, Oakland, Calif. makes ceramic, metal and glassy carbon foams using the “directional solidification of material from a super-heated liquidous state in an environment of overpressure and high vacuum”. It appears that this is essentially an investment-casting process. Such metallic and metallic-based foams have utility as structural sandwich panels (allowing for energy absorption), heat dissipation devices (due to high internal surface area and thermal conductivity), and as porous electrodes.

The fabrication of porous metal foams for use in orthopaedic applications is described by G. Ryan, A. Pandit and D. P. Apatsidis in Biomaterials 27 (2006) 2651-2670. They coated polyurethane foams with a slurry of Ti—Al—V powder in a water and ammonia solution, with thermal removal of the polyurethane scaffold and binder to create a titanium alloy with an 88% porosity.

Researchers at the Fraunhofer Institute for Manufacturing and Advanced Materials IFAM in Dresden, Germany have developed a reticulated porous titanium foam for use as load-bearing bone implants (Science Daily, Sept. 22, 2010). They saturated polyurethane foam with a solution containing a binder and fine titanium powder, which are subsequently heated, leaving behind a titanium-based semblance of the original foam structure.

Low-density metal foams have been made by impregnating polymer foam (i.e. polyurethane) with plaster, heating the resulting construct to pyrolyze the polymer and then injecting molten metal (such as aluminum or magnesium) into the pores, and subsequently removing the plaster with water, leaving behind a reticulated metal foam (see Y. Yamada, K. Shimojima, Y. Sakaguchi, M. Mabuchi, M. Nakamura, T. Asahina, T. Mukai, H. Kanahashi and K. Higashi, Mater. Sci. and Eng. A272 (1999) 455-458).

Poco Graphite, Inc., Decatur, Tex., USA has licensed U.S. Pat. No. 6,033,506 for making carbon and graphite foam by inert gas expansion of mesophase or isotropic pitch.

Various groups have published other methods for producing reticulated carbon foam. For example, Kelly, et al, in U.S. Pat. No. 6,979,513 B2 teaches the pyrolization of different types of wood (which contain a natural open pore cellular structure) for use as a carbon foam battery current collector.

M. Inagaki, T. Morishita, A. Kuno, T. Kito, M. Hirano, T. Suwa and K. Kusakawa in Carbon, 42 (2004) 497-502 describe a process to create a reticulated graphite foam by first impregnating (and imidizing) polyurethane foam to create a composite polyurethane/polyimide, followed by pyrolysis.

S. M. Manocha, K. Patel and L. M. Manocha in Indian J. of Engineering & Material Science, Vol. 17, 2010, 338-342 describe a method of making reticulated vitreous carbon by impregnating open-cell polyurethane foam with thermosetting phenolic resin and heating this construct in an inert atmosphere.

Microporous carbon polymers have also been produced using esoteric processes such as heat treating hyperbranched conjugated polymers having thermally degradable alkoxyl groups (see N. Kobayashi and M. Kijima, J. Mater. Chem. 2007, 17, 4289-296).

A review of some of the prior art, including methods for making glass-based foamed structures, is provided by Berrang in PCT Application PCT/CA2010/001809.

In many contemplated applications it would be advantageous to achieve a structure with lower cost, higher porosity and higher effective contact surface area without a large back-pressure for the passage of fluids or gases through the foam structure, than is offered by many of the prior art reticulated foams.

The production of reticulated polymer foams, such as polyurethane foam, usually requires the use of chemical or physical blowing agents to generate gas bubbles, where adjacent bubbles need to connect to create a contiguous path. Too much gas expansion causes “foam collapse”. Too little gas expansion creates closed-cell foam where adjacent cells do not connect. Accordingly, the process for producing open-cell polymer foam with substantially 100% open-cell ligament (sometimes called “strut”) skeletons with no membranes between cells is limited to a cell diameter from about 200 microns to about 4 millimeters. Pores between the cells are generally about 200 microns for cell diameters of about 300 microns.

Smaller cell diameters in a reticulated foam structure can be created, to a limited extent, by compressing the open-cell polymer foam template. Although reticulated polyurethane foam is an excellent template for making metal, metal alloy, metal oxide, carbon and glass foamed constructs, the cell diameter range is inherently limited by the foam-formation and curing process, and is thereby not suitable for applications requiring pore sizes less than about 200 microns.

A process for making low density nanoporous monolithic transition-metal foams (such as iron, cobalt, copper and silver) using a self-assembly combustion synthesis has been published (see B. C. Tappan, M. H. Huynh, M. A. Fliskey, D. E. Chavez, E. P. Luther, J. T. Mang, and S. F. Son, J. Am. Chem. Soc. 2006, 128, 6589-6594). Additional information on this process is provided by Tappan, et al. in U.S. Pat. No. 7,141,675. The Tappan product is made via an esoteric approach, using expensive materials to fabricated nanoporous structures (pore size of 20-200 nm). This process is limited to metals, and in final construct size, as it requires pressing the precursor material into pellets using a die, and firing in an inert atmosphere at high temperatures (i.e. 800° C.) to remove the carbon and nitrogen impurities. The small pore size would also create a large back-pressure for some applications, e.g. use as filters, and would be difficult to use as a porous electrode since fluid infusion therein would be impractical.

Generally speaking, the prior art polymer foam-making techniques suffer broad dimensional limitations. A certain size of cell and of shared cell wall must be achieved before the shared cell walls will readily open to create pores and a resulting reticulated structure. However, expanding the cells too much results in collapse of the foam structure. As a result, most reticulated (open-cell) foam structures have minimum cell diameters of about 200-300 microns and for such material, minimum pore sizes, i.e. openings between adjacent cells, in the range of about 100-200 microns. Using such reticulated polymer foam structures as templates to produce foam structures made of other materials imposes inherent limitations on the surface area and pore size available in the so-formed reticulated foam, for example to catalyze chemical reactions or to act as a conductive matrix.

The doping of rigid closed-cell (as opposed to open-cell) polyurethane foam with carbon nanomaterials so as to enhance the mechanical properties of the foam has been described. For example, Md. E. Kabir, M. C. Saha, and S. Jeelani in Mat. Sci. and Eng. A 459 (2007) 111-116 discuss doping of rigid closed-cell polyurethane to strengthen it with carbon nanofibers 5-10 nanometers long using a sonification technique. Similarly, L. Zhang, E. D. Yilmaz, J. Schjodt-Thomsen, J. C. Rauhe, and R. Pyrz in Composites Science and Technology 71 (2011) 877-884 describe the doping of rigid closed-cell polyurethane with multi-walled carbon nanotubes using a high-shear mixing procedure. The small size of the nanofibers and nanotubes suggests that they will be bound to individual cell ligaments and accordingly it is unlikely to significantly affect the overall porosity of the resulting structure or the contact surface area available in the foam.

It is an object of the present invention to provide a reticulated or “open cell” foam structure that provides a lower cost, a lower back-pressure, a lower density and a greater contact or reaction surface area in the foam than is provided by most prior art reticulated foams, particularly those used as templates to produce foams comprised of other materials, while also avoiding the problems that characterize prior art reticulated foams and reticulated foam-making techniques.

It is a further object of the invention to provide methods of producing non-polymer reticulated foams having such advantageous characteristics, using the polymer reticulated foam as a template.

Other objects of the invention will be appreciated by reference to this disclosure as a whole, including to the claims to which the reader is also referred.

### SUMMARY INVENTION

The present invention seeks to address the foregoing limitations by providing a reticulated foam wherein a primary open-cell foam structure is supplemented by a plurality of fibers within the cells and extending through inter-cell pores.

The incorporation of fibers into the foam modifies its effective porosity, increases the surface contact area and enhances its intrinsic mechanical support. The reticulated foam containing the fiber additives has utility in a number of applications such as for filtration, heat dissipation, or strong, lightweight mechanical structures. A fiber-enhanced reticulated polymer foam according to the invention is particularly useful as a template to fabricate fine-structure micro-porous reticulated foams made of metal, metal alloy, metal oxide, carbon-based or glass, some of which are particularly suited as battery electrodes.

A primary polymer foam according to the invention can be of one or more of polyurethane, polypropylene, polyethylene, polyester, polyether, acrylonitrile butadiene styrene, fluoropolymers, polyvinyl chloride, cellulose or latex, preferably polyurethane, or other suitable polymers including co-polymers.

The fibers introduced into the primary foam matrix extend across cells and inter-cell pores into adjacent cells. Accordingly, the fibers have an average length of between 2 and 10 times the average cell diameter, with the preferred range being from 2-5 times the average cell diameter.

The fibers may be of metal, a metal alloy, a metal oxide, a carbon material or glass. More specifically, the fibers can be made from metal such as tin, titanium, aluminum, chromium, vanadium, copper, nickel, iron or zinc, metal alloys such as titanium-nickel, titanium-aluminum-vanadium, iron-carbon, aluminum-copper-zinc-magnesium or eutectic alloys, metal oxides such as aluminum dioxide or titanium dioxide, or polymers such as nylon, polyacrylonitrile, polystyrene, polyamide, polyimide, PAN, PET, polycarbonate, polyurethane and polyvinyl esters for example. Additionally, the fibers can be made from an allotrope of carbon, for example, carbon material such as amorphous carbon, glassy carbon or graphite, or glass such as quartz, pyrex, or glasses doped with aluminum, sodium, lead or boron.

In one aspect, the invention comprises a reticulated open-cell foam having cells defined by a skeletal structure of ligaments and further comprising a plurality of fibers distributed substantially throughout said foam and extending across and between said cells of said foam.

In another aspect, the ratio of the average length of the fibers to the average diameter of said cells is at least 2:1. In another aspect, the average length of the fibers is between 400 microns and 40 millimeters.

In a further aspect, the invention comprises a reticulated foam construct composed substantially of a single non-polymer material and comprising a primary reticulated open-cell skeletal structure of ligaments, said ligaments defining cells, and a secondary structure of fiber-like elements distributed substantially throughout said primary structure, said fiber-like elements extending through and between adjacent cells.

The invention also comprises methods of producing the reticulated foam with fiber additives according to the invention.

According to the preferred embodiment, an additive comprised of thin-diameter, short-fibers made from a polymer, carbon material, metal, metal alloy, metal oxide or glass is added to the mix of chemicals used to prepare the reticulated polymer foam, prior to foam formation. During the foam-making process the fiber additive will then become randomly incorporated within, and bridge across the open cells, and through and across adjacent cells. Additionally, the fibers will then become rigidly incorporated into, and held within, the open-cell network of the final foam product, forming a porous fibrous web within each cell of the foam construct.

In another embodiment of the invention an additive comprised of thin diameter, short fibers made from metal, metal alloy, metal oxides, glass, carbon or any polymer is incorporated into reticulated polymer foam, preferably reticulated polyurethane foam, subsequent to foam formation. The reticulated foam is first soaked in an organic solvent, such as chloroform, which solvent causes the foam to expand in all dimensions, increasing the volume of the foam by double or more. This process expands both the cell diameter and pore size (i.e. openings between adjacent cells). By adding one or more fiber additives of metal, metal alloy, metal oxides, polymer, carbon material or glass to the solvent, and dispersing such additive within the solvent, it is then possible to disperse the added fibers within the cells of the expanded reticulated polymer. The solvent is then evaporated, causing the foam to shrink back to its original size, leaving the fiber additive entrained and held within the reticulated foam cells.

In one method aspect, the invention comprises a method for making a reticulated open-cell foam having cells defined by a skeletal structure of ligaments and further comprising a plurality of fibers distributed substantially throughout said foam and extending across and between the cells of the foam comprising the steps of adding the fibers to foam reactants used to make said skeletal structure of ligaments, and mixing the reactants including the added fibers.

In another aspect, the invention comprises a method for making a reticulated open-cell foam having cells defined by a skeletal structure of polymer ligaments and further comprising a plurality of fibers distributed substantially throughout said foam and extending across and between said cells of said foam comprising the steps of:
providing a starting reticulated open-cell foam having cells defined by a skeletal structure of polymer ligaments;
soaking the starting foam in an organic solvent containing a dispersion of one or more fiber additives substantially made of fibers of a material selected from among the group comprising polymer, metal, metal oxide, carbon, glass, so as to expand the cell diameters of the primary foam;
allowing said solvent to cause the starting foam to expand such that the average expanded cell diameter is at least the average length of the fibers; and,
causing or allowing said solvent to evaporate and the starting foam to shrink so as to entrain and retain the fibers across and between the cells.

According to the invention, the primary fiber-supplemented reticulated foam may be used as a template for making foam of a similar structure but in a different material than the primary foam.

According to one aspect, the invention comprises a method of making a reticulated foam construct composed substantially of a single non-polymer material and comprising a primary reticulated open-cell skeletal structure of ligaments and a secondary structure of fiber-like elements extending across and through the primary skeletal structure, comprising the steps of:
providing a starting reticulated foam comprising an open-cell skeletal structure of polymer ligaments and further comprising a plurality of fibers distributed substantially throughout the structure and extending across and between cells defined by the ligaments;
preparing a slurry comprising one or more materials selected front among the group comprising metal, metal alloy, metal oxide, carbon material, glass, silicon dioxide, silicon carbide, silicon nitride;
coating all surfaces of the starting foam with the slurry; and,
pyrolizing the polymer ligaments.

According to another aspect, the slurry may comprises nanomaterials. In another aspect, the method may comprises the further step of heating to sinter the slurry materials.

In another aspect, the invention comprises a method of making a reticulated foam construct composed substantially of a single non-polymer material and comprising a primary reticulated open-cell skeletal structure of ligaments and a secondary structure of fiber-like elements extending across and through the primary skeletal structure, comprising the steps of:
providing a starting reticulated foam comprising an open-cell skeletal structure of polymer ligaments and further comprising a plurality of fibers distributed substantially throughout the structure and extending across and between cells defined by the ligaments;
directly depositing a metal or metal alloy unto the surfaces of the starting foam;
pyrolizing the polymer ligaments; and,
sintering the metal or metal alloy.

In a further aspect, the invention comprises a method of making a reticulated foam construct composed substantially of a single non-polymer material and comprising a primary reticulated open-cell skeletal structure of ligaments and a secondary structure of fiber-like elements extending across and through the primary skeletal structure, comprising the steps of:
preparing a mixture of foam reactants designed to produce a reticulated open-cell skeletal structure of polymer ligaments, and a fiber additive, the fiber additive comprising chopped or milled fibers 600 microns to 1.5 millimeters long;
mixing the mixture;
adding to the mixed mixture a nanopowder, nanoparticles or nanofibers of a material selected from among the group comprising metal, metal alloy, metal oxide, carbon material, glass, silicon dioxide, silicon carbide, silicon nitride;
curing the resulting product; and,
heating the resulting product to burn off the polymer.

In a further aspect, the invention comprises the foregoing method wherein the nanopowder, nanoparticles or nanofibers are of carbon and further comprising the step of heating the resulting product to about 3000° C. to graphitize the carbon.

In yet a further aspect, the invention comprises a method of making a reticulated foam construct composed substantially of carbon and comprising a primary reticulated open-cell skeletal structure of ligaments and a secondary structure of fiber-like elements extending across and through the primary skeletal structure, comprising the steps of:
providing a starting reticulated foam comprising an open-cell skeletal structure of polymer ligaments and further comprising a plurality of fibers distributed substantially throughout the structure and extending across and between cells defined by the ligaments;
impregnating and imidizing the starting foam with poly(amide acid);
pyrolyzing to remove the polymer; and,
heating to about 3000° C. to graphitize the carbon,:

In another aspect, the invention comprises a method of making a reticulated foam construct composed substantially of a non-polymer and comprising a primary reticulated open-cell skeletal structure of ligaments and a secondary structure of fiber-like elements extending across and through the primary skeletal structure, comprising the steps of:
providing a starting reticulated foam comprising an open-cell skeletal structure of polymer ligaments and further comprising a plurality of fibers distributed substantially throughout the structure and extending across and between cells defined by the ligaments;
immersing the starting foam in an organic solution containing poly(hydridocarbyne) and a solvent;
evaporating the solvent to leave a coating of poly(hydridocarbyne) on the ligaments and fibers;
pyrolyzing to remove the polymer and fibers;
heating to about 1,000° C. to convert the poly(hydridocarbyne) to diamond or diamond-like carbon.

In another aspect, the invention comprises a method of making a reticulated foam construct composed substantially of a non-polymer and comprising a primary reticulated open-cell skeletal structure of ligaments and a secondary structure of fiber-like elements extending across and through the primary skeletal structure, comprising the steps of:
providing a starting reticulated foam comprising an open-cell skeletal structure of polymer ligaments and further comprising a plurality of fibers distributed substantially throughout the structure and extending across and between cells defined by the ligaments;
immersing the starting foam in an organic solution containing poly(hydridocarbyne) and a solvent;
evaporating the solvent to leave a coating of poly(hydridocarbyne) on the ligaments and fibers;
pyrolyzing to remove the polymer and fibers;
converting said poly(hydridocarbyne) to diamond by immersion in liquid ozone.

In yet another aspect, the invention comprises the use of the foam and foam constructs made according to the methods of the invention.

More specific aspects of the invention are disclosed in the claims, which should be deemed to be incorporated into this Summary of the Invention section and to which the reader is expressly referred.

The foregoing was intended as a broad summary only and of only some of the aspects of the invention. It was not intended to define the limits or requirements of the invention. Other aspects of the invention will also be appreciated by reference to the detailed description of the preferred embodiment.

### BRIEF DESCRIPTION OF THE DRAWINGS

The invention will be described by reference to the detailed description of the preferred embodiment and to the drawings thereof in which:

FIG. 1 is an illustration of a prior art reticulated polyurethane foam;

FIG. 2 is an illustration of a reticulated foam according to the preferred embodiment of the invention;

FIG. 3 is a process flow chart for a slurry-based process of making a reticulated foam construct according to a preferred embodiment of the invention;

FIG. 4 is a process flow chart for a slurry-based process of making an aluminum foam construct according a preferred embodiment of the invention;

FIG. 5 is a process flow chart for making a nickel-titanium alloy construct according to a preferred embodiment of the invention;

FIG. 6 is a process flow chart for a direct metallization process for making an electroless nickel construct according to a preferred embodiment of the invention;

FIG. 7 is a process flow chart for an in-situ fabrication process for a metal, metal alloy, metal oxide, carbon material or glass construct according to an alternative embodiment of the invention;

FIG. 8 is a process flow chart for an in-situ fabrication process for a graphite construct according to an alternative embodiment of the invention;

FIG. 9 is a process flow chart for an in-situ fabrication process for a nickel construct according to an alternative embodiment of the invention;

FIG. 10 is a process flow chart for an imidization process for making a graphite construct according to an alternative embodiment of the invention; and,

FIG. 11 is a process flow chart for a diamond fabrication process via direct coating with poly(hydridocarbyne) according to a preferred embodiment of the invention.

### DETAILED DESCRIPTION OF THE PREFERRED EMBODIMENTS

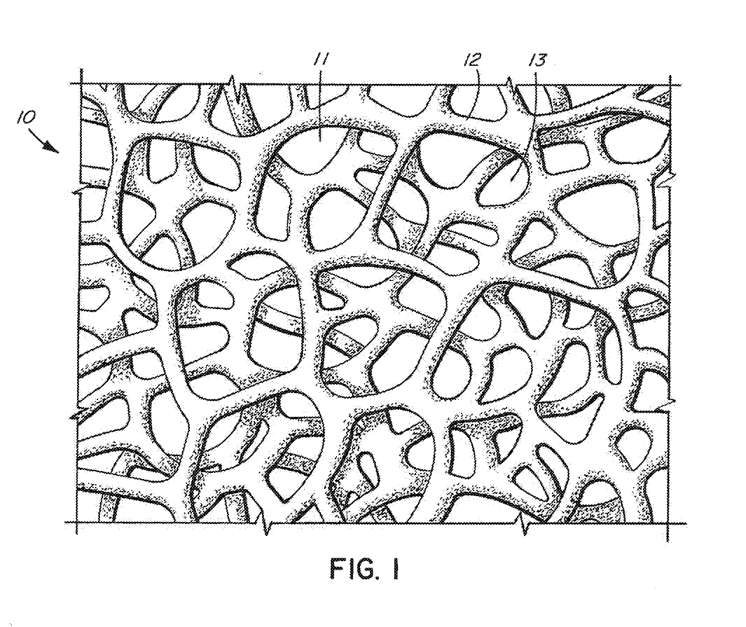

FIG. 1 is a three-dimensional sketch of commercially available reticulated polyurethane foam 10, having open cells 11 and ligaments or struts 12. Diameters of the open cells 11 can be in the range of 200 microns to 4 millimeters, which dimensions can be set by the production parameters. Pores 13 are in the range of 200 microns to about 3 millimeters across, which dimension is determined by the physical process of expanding bubbles during foam formation having common walls resulting from contact, which walls open, thereby forming a pore opening between adjacent cells.

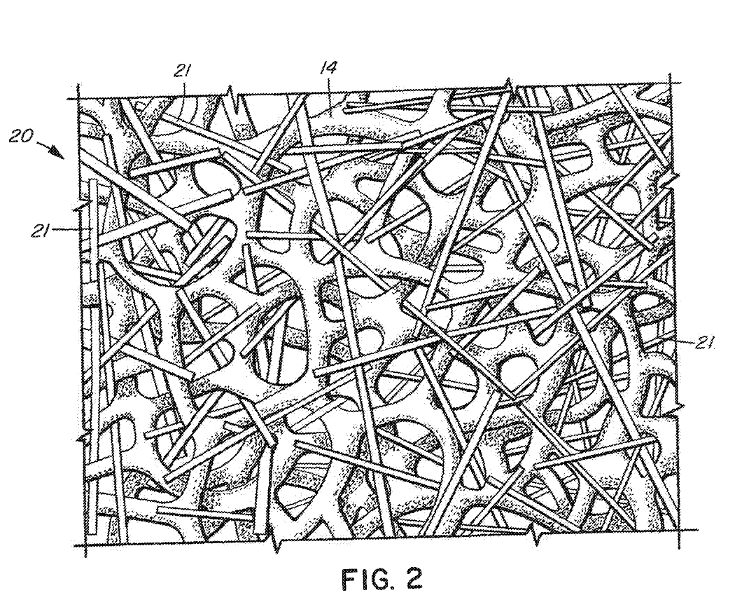

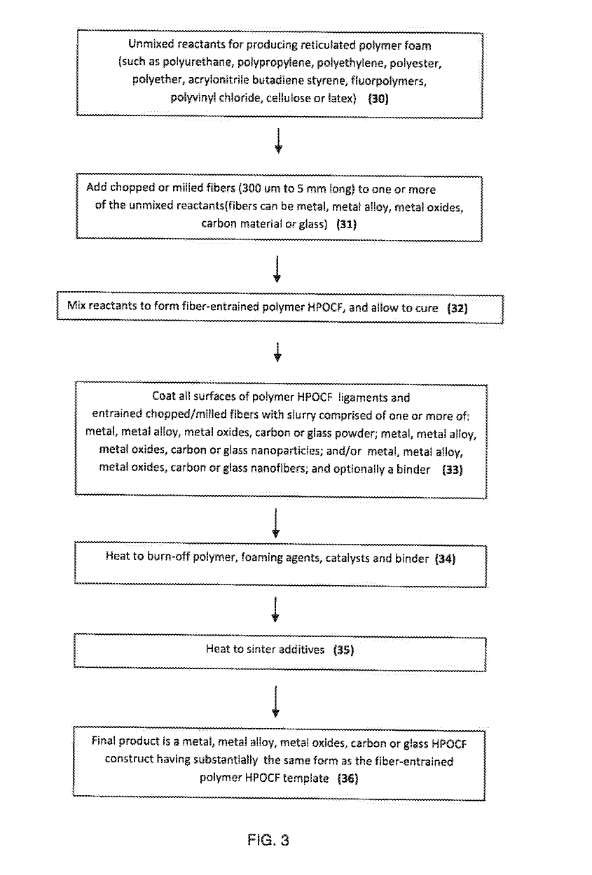

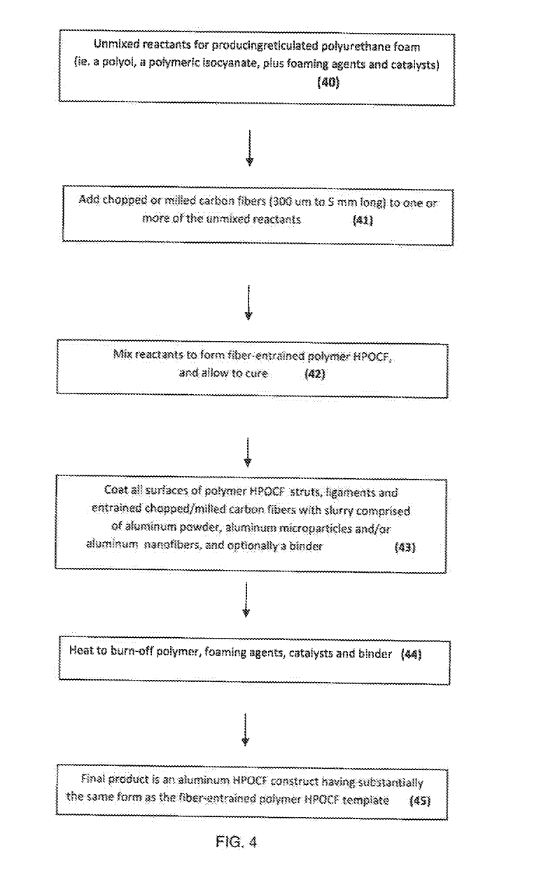

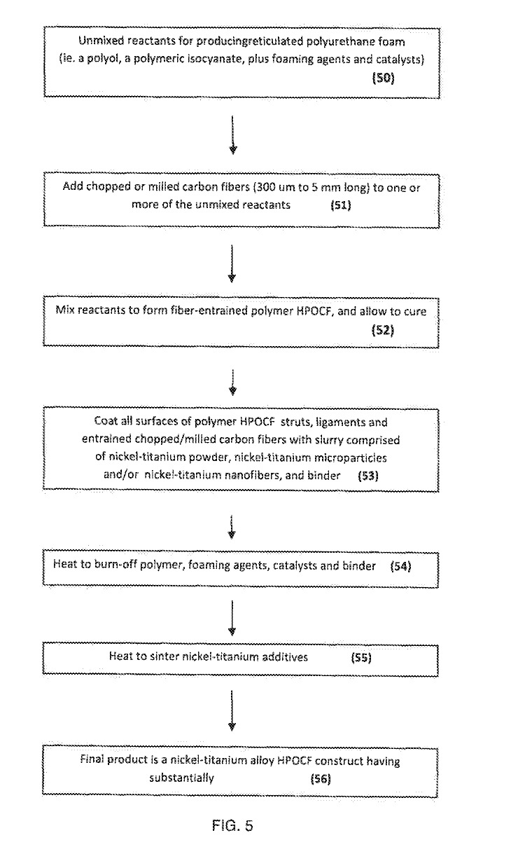

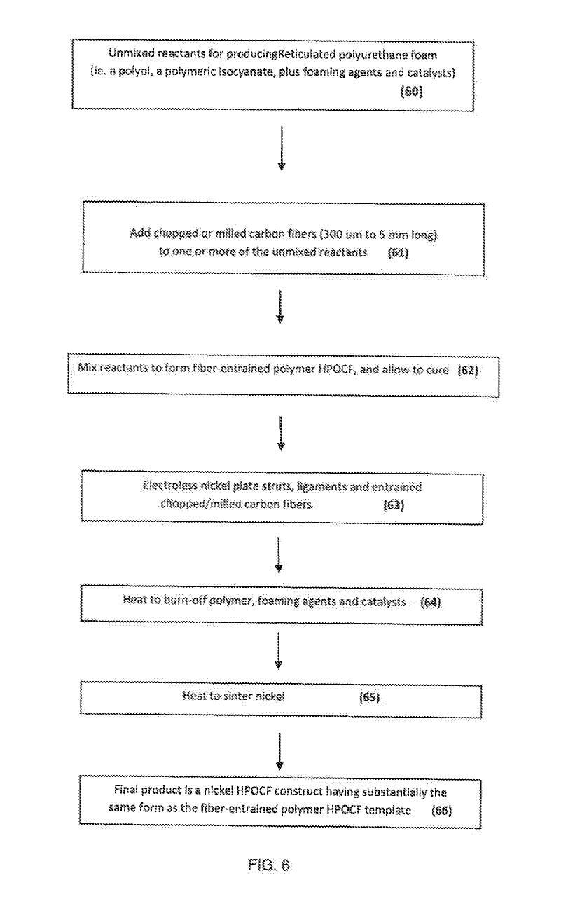

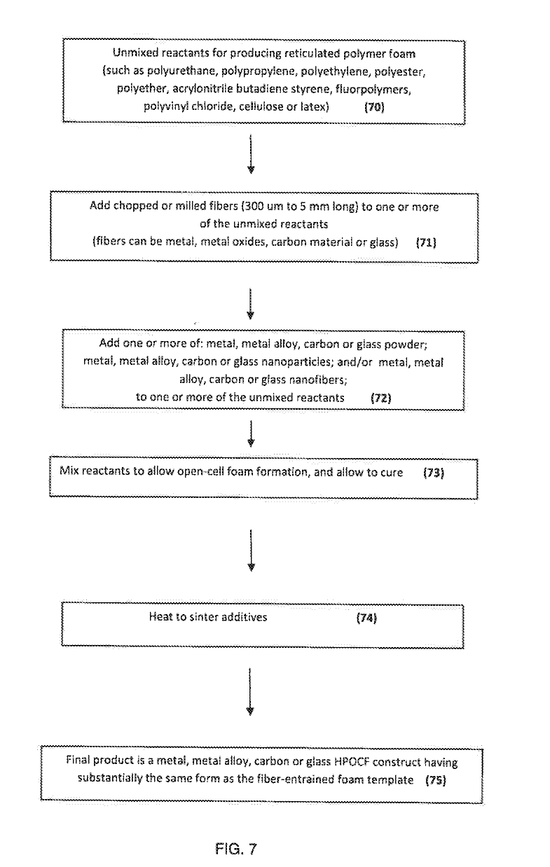

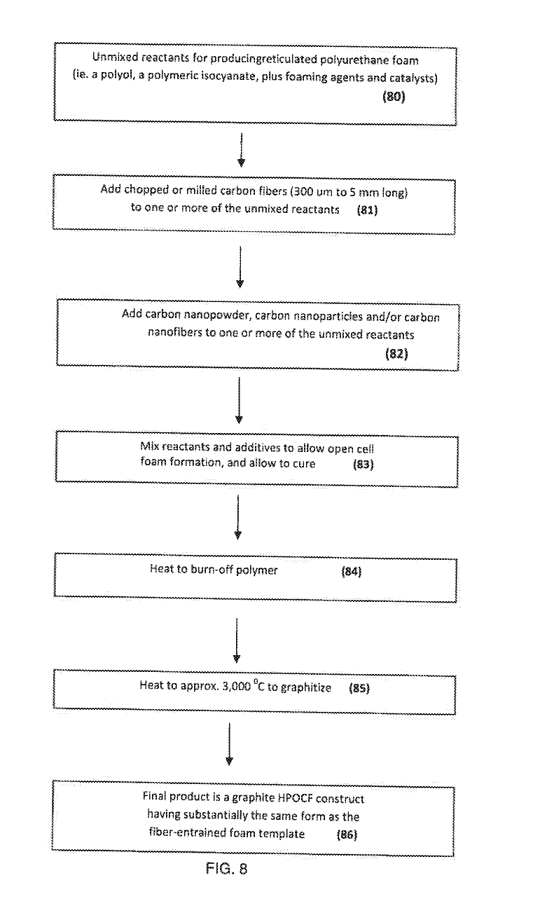

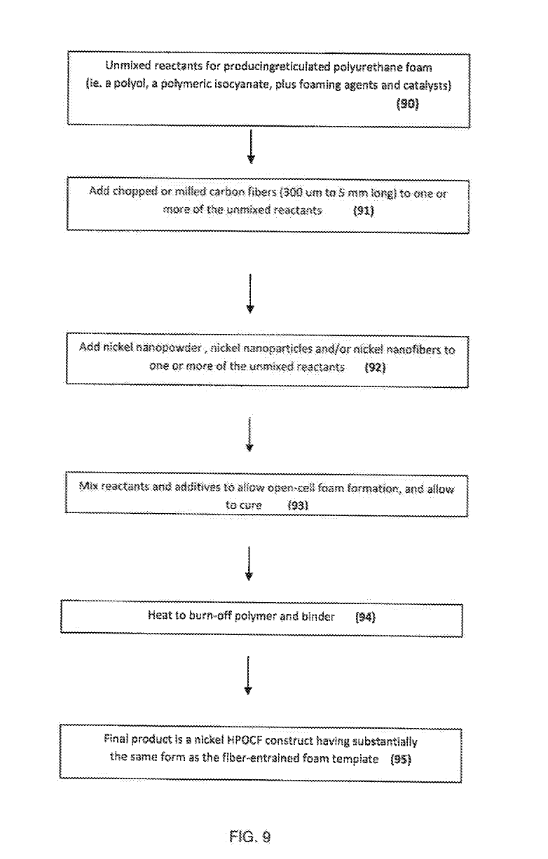

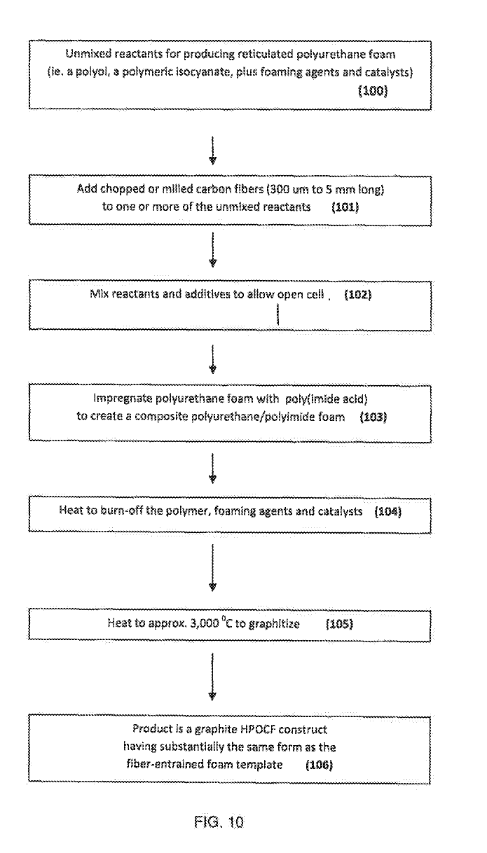

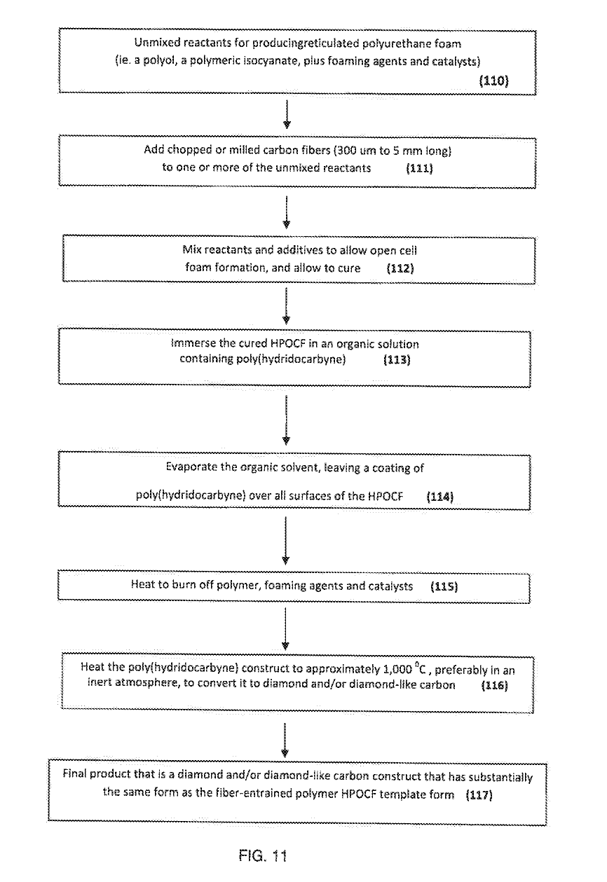

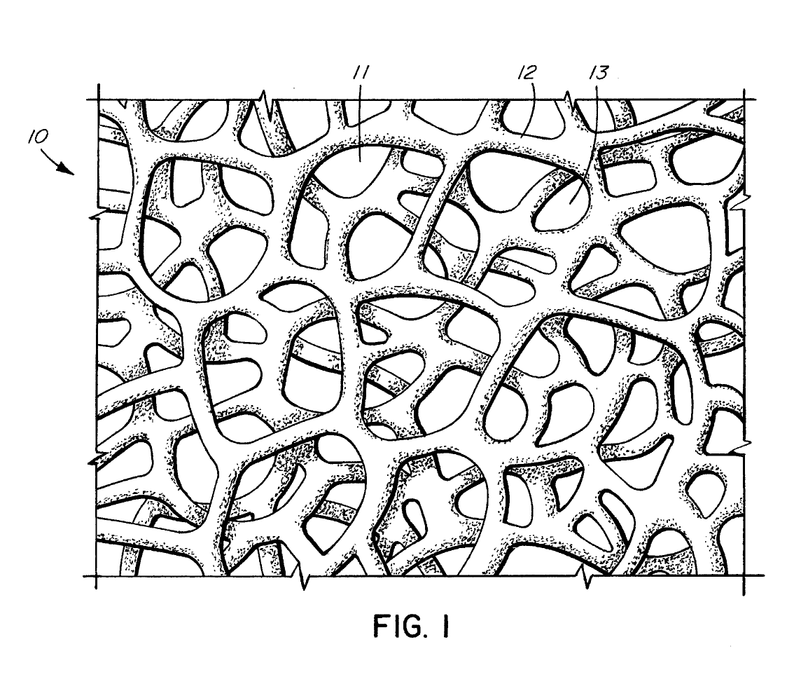

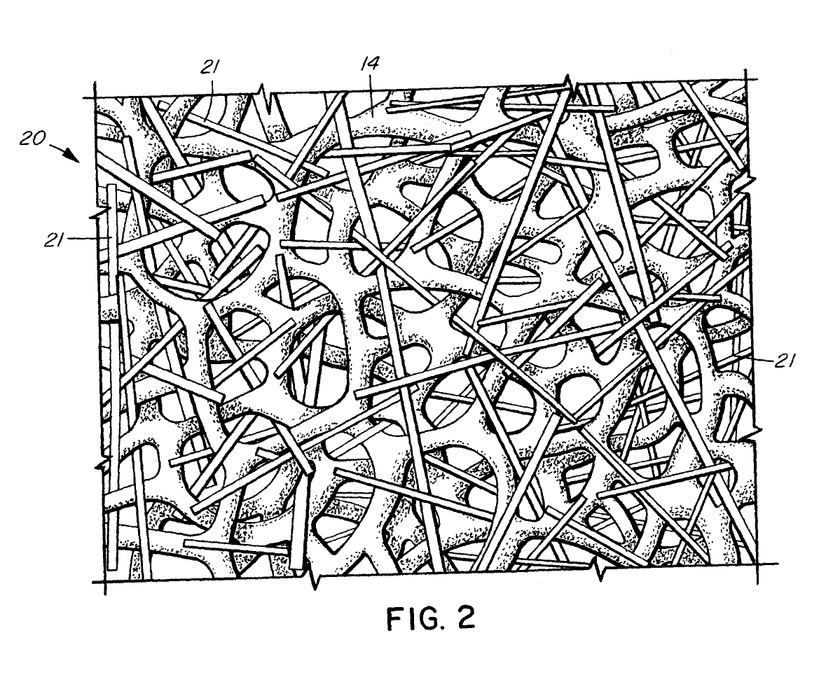

FIG. 2 illustrates a reticulated polyurethane foam 20 according to the preferred embodiment of the invention. The primary polymer foam structure characterized by ligaments 14 in FIG. 2 is preferably of the same dimensions as the finer-structured commercially producible prior art foams having cell diameters of about 200 microns to 4 millimeters (depending on the production process used to make the foam). In the preferred embodiment, the primary polyurethane foam has an average cell diameter of about 300 microns with an average ligament diameter of about 100 microns.

Foam 20 contains thin diameter, elongated but relatively short fibers 21 randomly incorporated within the primary structure provided by the reticulated polyurethane foam formed by the ligaments 14. The fibers generally bridge across cells, and generally through and across adjacent cells. Upon curing or otherwise making the foam, the fibers 21 remain held within the primary open cell polymer foam structure.

The average length of fibers 21 is 2-10 times the average diameter of open cells and preferably 2-5 times. That specification allows for the fibers to generally extend into at least one adjacent cell, thereby promoting a finer overall structure and smaller effective inter-cell porosity. Accordingly, the average fiber lengths would be at least 400 microns to 40 millimeters depending on the primary foam. The preferred embodiment uses an average fiber length of 600 microns (twice the average cell diameter of 300 microns).

The cross-section of the fibers can be any shape but in the preferred embodiment is round. The ratio of the average cross-sectional area of the fibers to the reticulated foam ligament cross-sectional area is less than 1 and preferably between 0.01 and 0.1 such that in the preferred embodiment, the average diameter of such a cross-sectional area would give a fiber with a diameter of about 1 to 10 microns.

The addition of the fibers to the primary reticulated foam structure reduces the effective pore size through the matrix of foam and fibers. The number of fibers per volume, and the average fiber diameter and length will determine the effective pore density and the effective pore size and hence the porosity of the resulting composite foam structure.

In the preferred embodiment, a sufficient number of fibers are added to the primary polymer foam to result in a plurality of fibers traversing and intersecting in most of the cells of the foam. The web of fibers thus created provides a micro-porous matrix in addition to that provided by the inter-cell pores with effective inter-fiber pore sizes of as low as 50 nanometers. The matrix of fibers also increases the contact surface area of the foam construct and enhances the structural rigidity and mechanical support provided by the foam. The effective pore size taking into account the fibers and the underlying ligand structure can be made very dense, from 50-100 nanometers, to 1-2 millimeters, depending upon the intended application. In this context, the “pore size” refers to the diameter of the largest particle that is able to just penetrate and pass through such randomly intersecting fibers and ligands. For example, if a particle with a diameter of 3 micron is just able to pass through a planar section of space bounded by one or more fibers or/and one or more foam ligands, then the pore size of such opening within the planar section of space would be 3 microns. The density, volume/volume or weight/weight (v/v or w/w) of the entrained fiber additive within the polyurethane foam can be in the range of 0.5% to 85%, preferably 10% to 30%, the narrower range being preferred for battery electrodes for example.

Many fiber additives such as metal, metal alloys or metal oxides, or polymers such as nylon, polyacrylonitrile, polystyrene, polyamide, polyimide, PAN, PET, polycarbonate, polyurethane and polyvinyl esters, can be made via a nanospinning process, which process is known to those skilled in the art. Carbon-based material and glass fibers of various diameters and lengths (i.e. chopped or milled) are also commercially available.

The preferred embodiment of a process for making the fiber-enhanced reticulated foam according to the invention will now be described. An additive comprised of suitably thin-diameter, short-fibers made from a polymer, carbon material, metal, metal alloy, metal oxide or glass is added to the reactants that would normally be used to prepare the reticulated polymer foam. The reactants including the fiber additive(s) are then mixed to create the foam. During the foam-making process the fibers will become randomly incorporated within, in and bridge across the open cells, and through and across adjacent cells. Upon curing of the foam, the fibers will be rigidly incorporated into, and held within, the open-cell network of the final foam product, forming a porous fibrous web extending across throughout the skeletal structure of ligaments that also define the cells of the foam.

In an alternative method of making the foam, the fibers are added subsequent to the formation of the primary foam structure. This method is particularly well suited to primary foam structure made of polyurethane. The primary reticulated foam is first soaked in an organic solvent, such as chloroform, which solvent causes the foam to expand in all dimensions, increasing the volume of the foam by a factor of two or more and in any event to an extent that the expanded cell diameters are generally more than the length of the fibers (by reference to the average of each). The solvent expansion process expands both the cell diameter and the inter-cell pore size. By adding one or more fiber additives of metal, metal alloy, metal oxides, polymer, carbon material or glass to the solvent, and dispersing such additive within the solvent, it is then possible to entrain the additive fibers within the cells of the expanded reticulated polymer. The solvent is then allowed to evaporate or caused to evaporate, causing the foam to shrink back to about its original size, leaving the fiber additive entrained and held within and between the reticulated foam cells.

The primary fiber-enhanced foam construct according to the invention can then be used as a template to create a structurally similar foam of metal, metal alloy, metal oxide, carbon material or glass. Metal foam ligaments fabricated using a polymer foam as a template can be of one or more of nickel, titanium, iron, aluminum or copper. Metal alloy foam ligaments can be comprised of one or more of nickel-titanium, titanium-aluminum-vanadium, iron-carbon, aluminum-copper-zinc-magnesium. Metal oxide foam ligaments can be titanium dioxide or aluminum oxide. Carbon material foam ligaments can be comprised of any allotrope of carbon. Glass foam ligaments can be comprised of one or more of glass, such as quartz, pyrex, or glasses doped with aluminum, sodium, lead and/or boron.

A preferred embodiment of the fiber-enhanced reticulated (i.e. open cell) polymer foam that is subsequently used as a template to produce a nickel-foam construct for use as a battery electrode is as follows:
Polymer template: polyurethane
average cell diameter: 300 microns
average ligament diameter: 100 microns
fiber additive: carbon
average fiber length: 600 microns to 1.5 millimeters
average fiber diameter: 10 microns
fiber shape: round
fiber density: 10-30% v/v or w/w

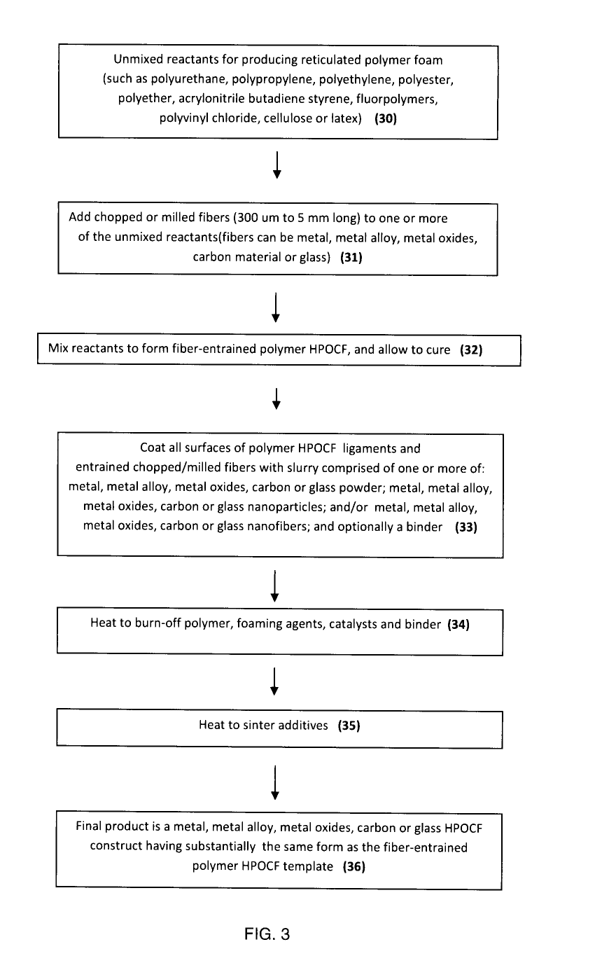

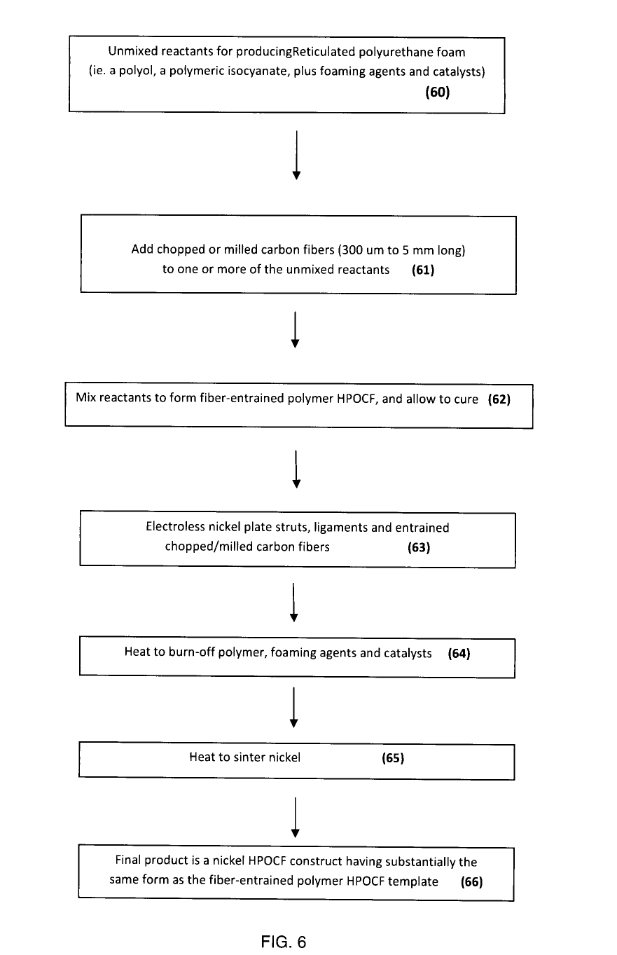

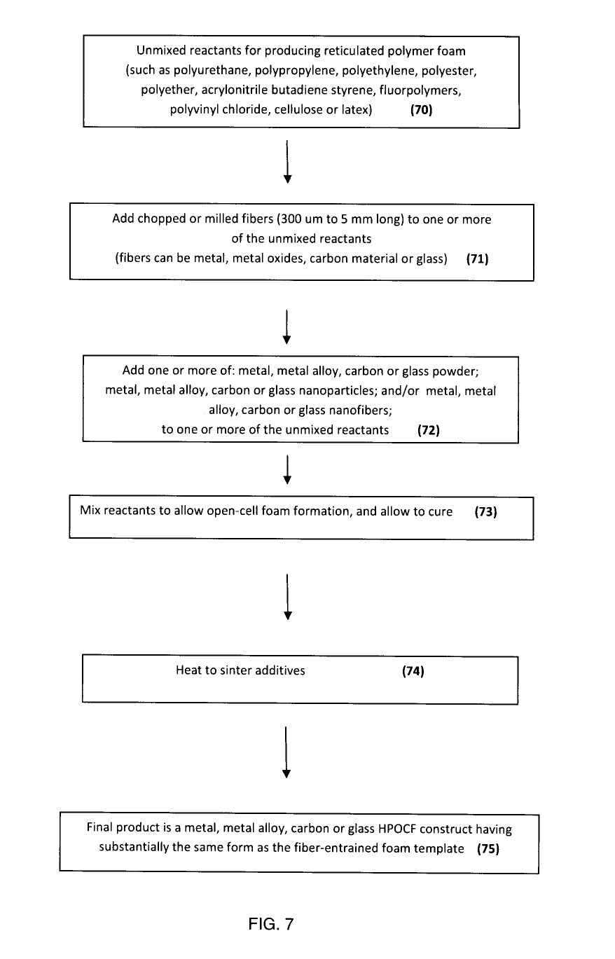

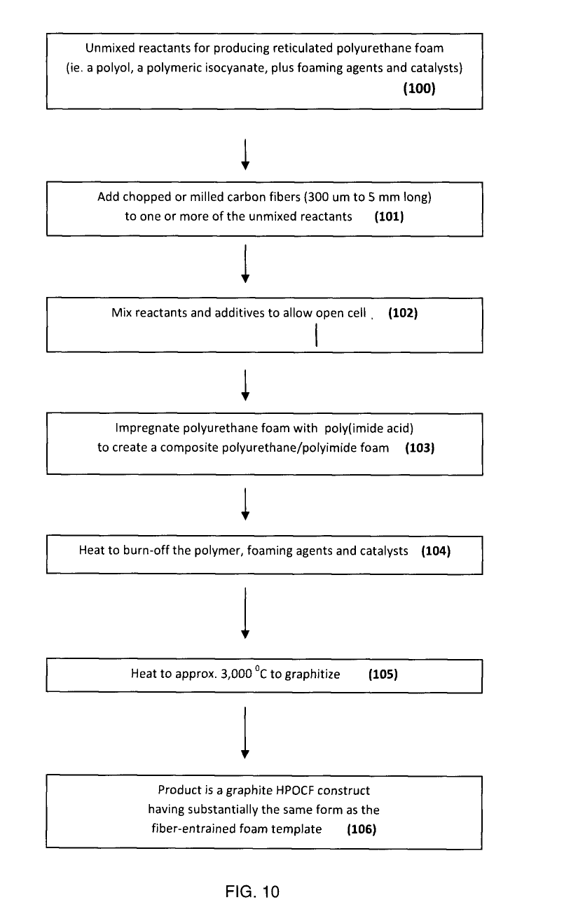

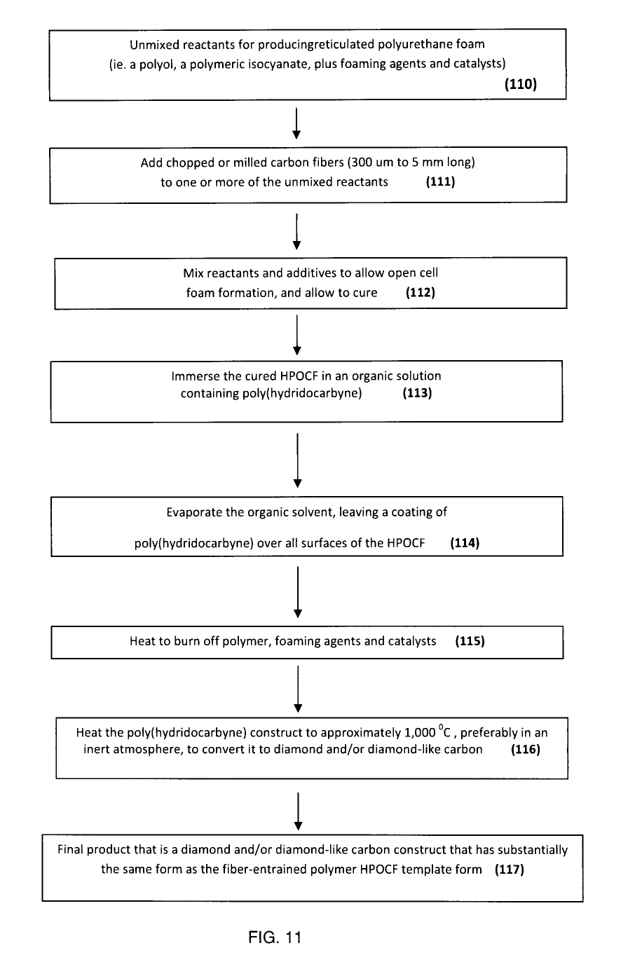

As discussed above, an important use of the fiber-enhanced reticulated polymer foam according to the invention is as a template to produce a fine-structured, microporous reticulated foam of metal, metal alloy, metal oxide, carbon or glass. The following describes the preferred processes for creating such constructs according to the invention. In summary they include:
(a) A slurry process as described by reference to FIGS. 3, 4 and 5.
(b) A direct metallization process such as nickel carbonyl deposition, metal sulphate (or nitrate) deposition, or electroless nickel deposition. The electroless nickel process is described by reference to FIG. 6.
(c) An in-situ process as described by reference to FIGS. 7, 8, and 9.
(d) An imidization process as described by reference to FIG. 10.
(e) An direct coating process with poly(hydridocarbyne) as described by reference to FIG. 11.

In the following descriptions, the term HPOCF (an acronym for “hybrid-porosity open cell foam”) will sometimes be used to refer to the fiber-enhanced reticulated foam according to the invention, whether it is a fiber-enhanced reticulated polymer foam, or a reticulated foam made using the fiber-enhanced reticulated polymer foam as a template.

Slurry Process

FIG. 3 is a flow chart for a metal, metal alloy, metal oxide, carbon material or glass HPOCF fabrication process using a slurry approach. Starting (30) with unmixed reactants for producing reticulated polymer foam having an average cell diameter of about 300 microns, chopped or milled fibers of average length between 600 microns and 1.5 millimeters are added (31) to the unmixed reactants, and thoroughly mixed (32) therein using, for example, mechanical stirring and/or sonification. The fiber-entrained polymer HPOCF is then allowed to cure.

All surfaces of the polymer HPOCF are then coated (33) with a slurry comprised of one or more metal, metal alloy, metal oxide, carbon material or glass, in the form of nanopowder, nanoparticles or nanofibers, including, optionally, a binder. In one embodiment, the slurry can also contain silicon dioxide, silicon carbide or silicon nitride. Nanopowder and nanoparticle diameters are preferably 10 to 1,000 nanometers. Nanofiber lengths are preferably 20 nanometers to 50 microns, with diameters ranging from 10 nanometers to 20 microns. In one embodiment, the nanopowder can be in the form of hollow spheres.

Metal nanopowder, nanoparticles or nanofibers can be made from, for example, nickel, titanium, iron, aluminum or copper. Metal alloys in the form of nanopowder, nanoparticles or nanofibers can be of nickel-titanium, titanium-aluminum-vanadium, iron-carbon, aluminum-zinc-copper-magnesium, etc. Metal oxide in the form of nanopowder, nanoparticles or nanofibers can be comprised of titanium dioxide or aluminum oxide. Carbon nanopowder, nanoparticles or nanofibers can be comprised of any allotrope of carbon. Glass nanopowder, nanoparticles or nanofibers can be comprised of any type of glass, such as quartz, pyrex, or aluminum, sodium, lead and/or boron doped glasses.

The slurry coated construct is subsequently heated (34) to burn-off the polymer, foaming agents, catalysts and any binder, and heated further (35) at higher temperature to sinter the additives, producing a final product 36 that is a metal, metal alloy, metal oxide, carbon or glass HPOCF construct that has substantially the same form as the fiber-entrained polymer HPOCF template.

In the case where the final HPOCF construct is comprised of an oxide such as TiO₂ or Al₂O₃, such construct can be further treated to reduce the oxides to their pure metal form using, preferably, the known FCC Cambridge Process (developed in 1997 at the University of Cambridge), which process uses an electrochemical method to remove the oxygen from, for example, TiO₂ in a solution of molten CaCl₂ (see also U.S. Pat. No. 6,921,473 B2). The resulting pure titanium foam construct has great utility for use in medical implants as it is biocompatible, ductile, strong and light. Applications include use as a porous-walled stent which allows for cell growth into the stent wall, as a scaffold for bone and tissue support, and as dental support structures.

A similar reduction process using molten LiCl can be used to reduce Al₂O₃ to Al (see U.S. Pat. No. 6,921,473 B2),

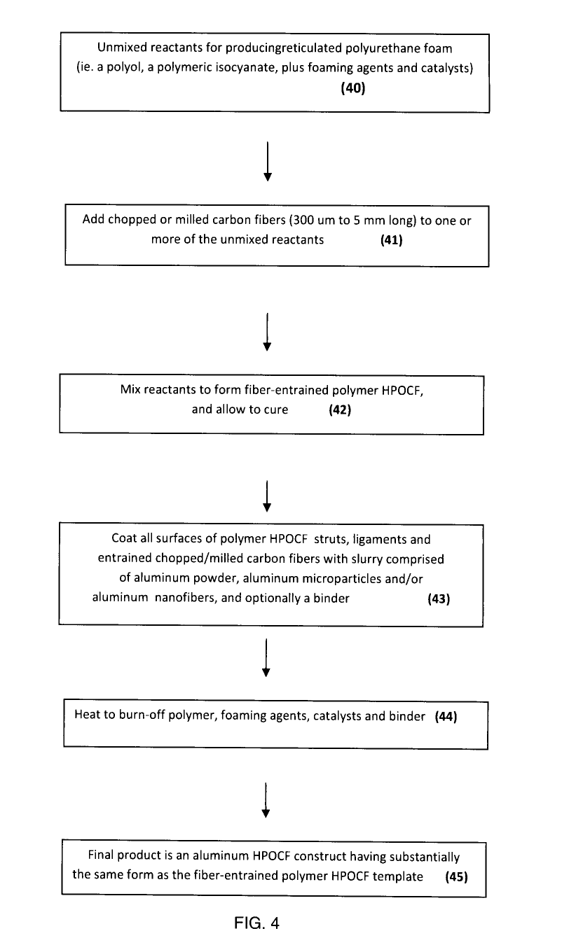

FIG. 4 is a flow chart for a slurry approach for making hybrid-porosity open cell aluminum foam using a polyurethane foam template having an average cell diameter of about 300 microns.

Starting with unmixed reactants (40) for producing reticulated polyurethane foam (i.e. liquid isocyanate and liquid polyols, containing a catalyst and other additives) having an average cell diameter of about 300 microns, chopped or milled fibers 600 microns to 1.5 millimeters long are added (41) to the unmixed reactants, and thoroughly mixed therein using, for example, mechanical stirring and/or sonification, The fiber-entrained polyurethane HPOCF so is then allowed to cure (42).

All surfaces of the fiber-entrained polyurethane HPOCF are then coated (43) with a slurry comprised of aluminum in a form of nanopowder, nanoparticles and/or nanofibers, including, optionally, a binder.

The aluminum slurry-coated construct is subsequently heated (44) to burn-off the polymer, foaming agents, catalysts and any binder, and heated further at higher temperature to sinter the aluminum, producing a final aluminum HPOCF construct 45 that has substantially the same form as the fiber-entrained polyurethane HPOCF template.

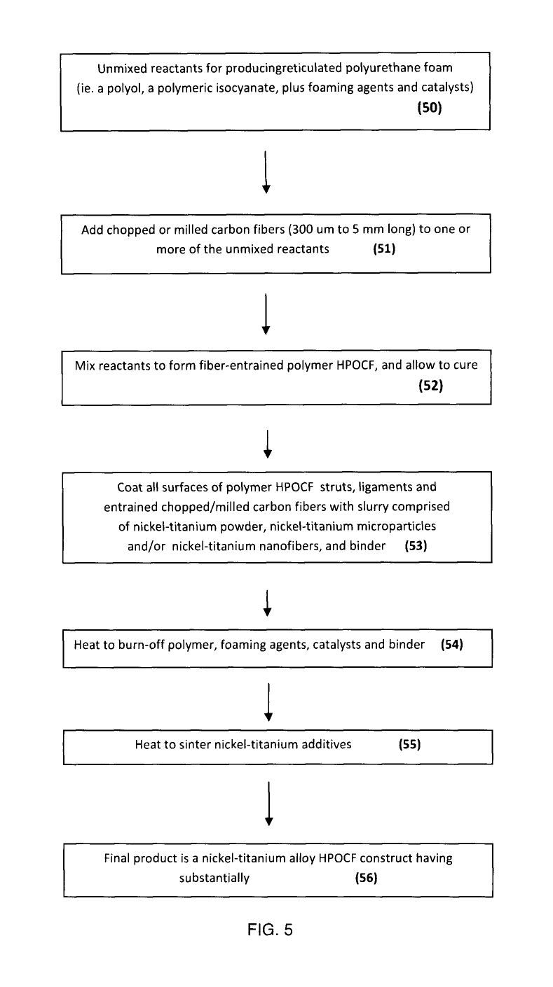

FIG. 5 is a flow chart for a slurry approach for making a nickel-titanium alloy HPOCF using a polyurethane foam template.

Starting with unmixed reactants (50) for producing reticulated polyurethane foam i.e. liquid isocyanate and liquid polyols, containing a catalyst and other additives) having an average cell diameter of about 300 microns, chopped or milled fibers 600 microns to 1.5 millimeters long are added (51) to the unmixed reactants, and thoroughly mixed (52) therein using, for example, mechanical stirring and/or sonification. The fiber-entrained polyurethane HPOCF is then allowed to cure.

All surfaces of the fiber-entrained polyurethane HPOCF are then coated (53) with a slurry comprised of a nickel-titanium alloy in a form of nanopowder, nanoparticles and/or nanofibers, including, optionally, a binder.

The nickel-titanium alloy slurry-coated construct is subsequently heated (54) to burn-off the polymer, foaming agents, catalysts and any binder, and heated further (55) at higher temperature to sinter the nickel-titanium alloy, producing a final nickel-titanium alloy HPOCF construct 56 that has substantially the same form as the fiber-entrained polyurethane HPOCF template.

In one embodiment, the ratio of the nickel/titanium is 55/45, which alloy is know as “nitinol” which has a memory shape at a specific temperature, and is both strong and biocompatible, making such an alloy useful, especially in medical applications such as implants and stents,

Direct Metallization Process

A direct metallization process such as nickel carbonyl deposition, metal sulphate (or nitrate) deposition, or electroless nickel deposition can be used to metallize hybrid-porosity open cell polyurethane foam.

(a) Electroless Nickel Deposition

A flow chart for an electroless nickel process is shown in FIG. 6.

Starting with unmixed reactants (60) for producing reticulated polyurethane foam (i.e. liquid isocyanate and liquid polyols, containing a catalyst and other additives) having an average cell diameter of about 300 microns, chopped or milled fibers 600 microns to 1.5 millimeters long are added (61) to the unmixed reactants, and thoroughly mixed (62) therein using, for example, mechanical stirring and/or sonification. The fiber-entrained polyurethane HPOCF is then allowed to cure.

All surfaces of the polyurethane HPOCF are then electroless nickel plated (63). The nickel coated construct is subsequently heated (64) to burn-off the polymer, catalysts and any foaming agents, and heated further (65) at higher temperature to sinter the nickel, producing a final nickel HPOCF construct 66 that has substantially the same form as the fiber-entrained polyurethane HPOCF template.

(b) Metal Sulphate and Metal Nitrate Impregnation

A similar direct metallization process can be used by impregnating polyurethane foam with a solution of nickel, copper or lead sulphate, or nickel, copper or lead nitrate.

Starting with unmixed reactants for producing reticulated polyurethane foam (i.e. liquid isocyanate and liquid polyols, containing a catalyst and other additives) having an average cell diameter of about 300 microns, chopped or milled fibers 600 microns to 1.5 millimeters long are added to the unmixed reactants, and thoroughly mixed therein using, for example, mechanical stirring and/or sonification. The fiber-entrained polyurethane HPOCF is then. allowed to cure.

All surfaces of the polyurethane HPOCF are then impregnated with a solution of nickel, copper or lead sulphate, or nickel, copper or lead nitrate.

The impregnated construct is subsequently heated to burn-off the polymer, catalysts and any foaming agents, and additives producing a final nickel, copper or lead HPOCF construct that has substantially the same form as the fiber-entrained polyurethane HPOCF template.

(c) Nickel Carbonyl Deposition

A similar direct nickel metallization process can be used by decomposing nickel carbonyl gas in the presence of an open-cell polyurethane foam substrate.

Starting with unmixed reactants for producing reticulated polyurethane foam (i.e. liquid isocyanate and liquid polyols, containing a catalyst and other additives) having an average cell diameter of about 300 microns, chopped or milled fibers 600 microns to 1.5 millimeters long are added to the unmixed reactants, and thoroughly mixed therein using, for example, mechanical stirring and/or sonification. The fiber-entrained polyurethane HPOCF is then allowed to cure.

All surfaces of the polyurethane HPOCF are then coated with nickel by infusing the polyurethane foam with nickel carbonyl gas and heating to decompose the nickel carbonyl gas, and depositing the nickel onto the polyurethane foam.

The nickel coated construct is subsequently heated to burn-off the polymer, catalysts and any foaming agents, and additives producing a final nickel HPOCF construct that has substantially the same form as the fiber-entrained polyurethane HPOCF template.

In-situ Process

FIG. 7 is a flow chart for a metal, metal alloy, metal oxide, carbon material or glass HPOCF fabrication process via an in-situ approach. Starting with unmixed reactants (70) for producing reticulated polymer foam having an average cell diameter of about 300 microns, chopped or milled fibers 600 microns to 1.5 millimeters long are added (71) to the unmixed reactants, and thoroughly mixed therein using, for example, mechanical stirring and/or sonification.

One or more metal, metal alloy, metal oxide, carbon material or glass, in a form of nanopowder, nanoparticles or nanofibers are also added (72) to the unmixed reactants. In one embodiment, silicon dioxide, silicon carbide or silicon nitride can also be added. Nanopowder and nanoparticle diameters are preferably 10 to 1,000 nanometers. Nanofiber lengths are preferably 20 nanometers to 50 microns, with diameters ranging from 10 nanometers to 20 microns. In one embodiment, the form of the nanopowder can be hollow spheres.

The concentration of the additive components is 5% to 95% (w/w or v/v), preferably 20% to 75%, preferably 30% to 60%. The polyurethane foam reaction not only creates the reticulated construct, but it also acts as a binder to hold the additive components in place until fused via sintering.

Metal nanopowder, nanoparticles or nanofibers can be made from, for example, nickel, titanium, iron, aluminum or copper. Metal alloys in the form of nanopowder, nanoparticles or nanofibers can be, for example, comprised from nickel-titanium, titanium-aluminum-vanadium, iron-carbon, aluminum-copper-zinc-magnesium, etc.

Metal oxide in the form of nanopowder, nanoparticles or nanofibers can be comprised from titanium dioxide or aluminum oxide. Carbon nanopowder, nanoparticles or nanofibers can be comprised of any allotrope of carbon. Glass nanopowder, nanoparticles or nanofibers can be comprised on any type of glass, such as quartz, pyrex, or aluminum, sodium, lead and/or boron doped glasses.

The doped reactants are then mixed (73) to allow foam formation and curing.

The cured foam construct is subsequently heated to burn-off the polymer, catalysts and any binder, and heated further (74) at higher temperature to sinter the additives producing a final product 75 that is a metal, metal alloy, metal oxide, carbon or glass HPOCF construct that has substantially the same form as the fiber-entrained polymer HPOCF template form.

In the ease where the HPOCF construct is comprised of an oxide such as TiO₂ or Al₂O₃, such construct can be further treated to reduce the oxides to their pure metal form as per the FCC Cambridge method described for the slurry process.

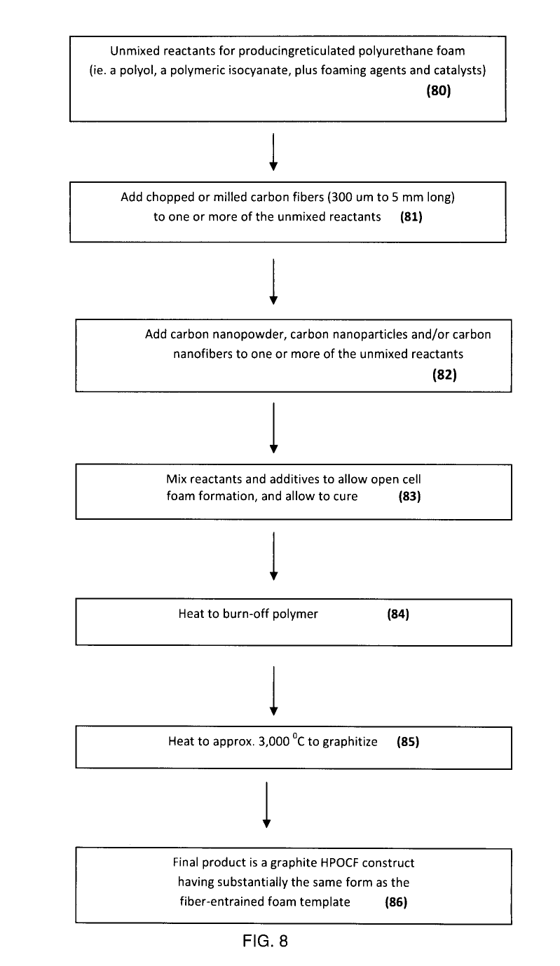

FIG. 8 is a flow chart for a graphite HPOCF fabrication process via an in-situ approach. Starting with unmixed reactants (80) for producing reticulated polyurethane foam having an average cell diameter of about 300 microns, chopped or milled fibers 600 microns to 1.5 millimeters long are added (81) to the unmixed reactants, and thoroughly mixed therein using, for example, mechanical stirring and/or sonification.

Carbon nanopowder, nanoparticles or nanofibers are then added to (82), and mixed with, one or more of the reactants. The doped reactants are then mixed (83) to allow foam formation and curing.

The cured foam construct is subsequently heated (84) to burn-off the polymer, foaming agents, catalysts and any binder, and heated further at higher temperature to fuse the carbon additives.

The carbon construct is then heated (85) to approximately 3,000° C. to graphitize the carbon, producing a final product 86 that is a graphite construct that has substantially the same form as the fiber-entrained. polymer HPOCF template form.

The carbon nanopowder, nanoparticles or nanofibers diameters are preferably 10 to 1,000 nanometers. Carbon nanofiber lengths are preferably 20 nanometers to 50 microns, with diameters ranging from 10 nanometers to 20 microns.

The concentration of the additive carbon material is 5% to 95% (w/w or v/v), preferably 20% to 75%, preferably 30% to 60%. The polyurethane foam reaction not only creates the reticulated construct, but it also acts as a binder to hold the additive carbon in place until fused by heating.

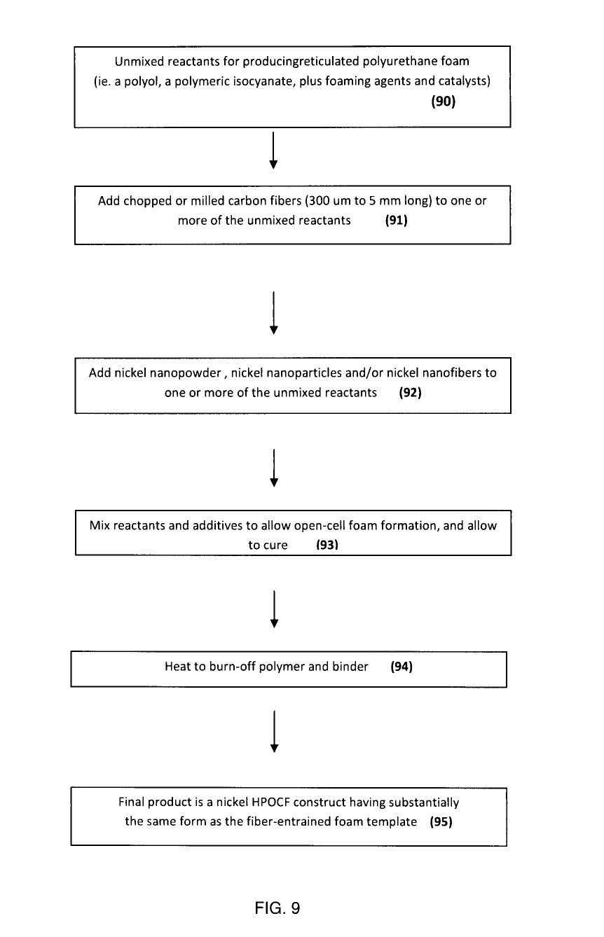

FIG. 9 is a flow chart for a nickel HPOCF fabrication process via an in-situ approach. Starting with unmixed reactants (90)for producing reticulated polyurethane foam having an average cell diameter of about 300 microns, chopped or milled fibers 600 microns to 1.5 millimeters long are added (91) to the unmixed reactants, and thoroughly mixed therein using, for example, mechanical stirring and/or sonification.

Nickel nanopowder, nanoparticles or nanofibers are then added to (92), and mixed with, one or more of the reactants. The doped reactants are then mixed (93) to allow foam formation and curing.

The cured foam construct is subsequently heated (94) to burn-off the polymer, foaming agents, catalysts and any binder.

The final product is a nickel construct 95 that has substantially the same form as the fiber entrained polymer HPOCF template form.

The nickel nanopowder, nanoparticles or nanofibers diameters are preferably 10 to 1,000 nanometers. Nickel nanofiber lengths are preferably 20 nanometers to 50 microns, with diameters ranging from 10 nanometers to 20 microns.

The concentration of the additive nickel material is 5% to 95% (w/w or v/v), preferably 20% to 75%, preferably 30% to 60%. The polyurethane foam reaction not only creates the reticulated construct, but it also acts as a binder to hold the additive nickel in place.

An Imidization Process

FIG. 10 is a flow chart for a graphite HPOCF fabrication process via an imidization approach. Starting with unmixed reactants (100) for producing reticulated polymer foam having an average cell diameter of about 300 microns, chopped or milled fibers 600 microns to 1.5 millimeters long are added (101) to the unmixed reactants, and thoroughly mixed therein using, for example, mechanical stirring and/or sonification.

The doped reactants are then mixed (102) to allow foam formation and curing. The cured HPOCF is then impregnated (and imidized) (103) with poly(amide acid) and heated (104) to burn off the polymer, foaming agents, and catalysts. In one embodiment, the cured HPOCF is impregnated with thermosetting phenolic resin, followed by pyrolysis of the HPOCF.

The resulting carbon construct is then heated (105) to approximately 3,000° C. to graphitize the carbon, producing a final product that is a graphite construct 106 that has substantially the same form as the fiber-entrained polymer HPOCF template form.

An Direct Coating Process with Poly(hydridocarbyne)

FIG. 11 is a flow chart for a diamond HPOCF fabrication process via direct coating with poly(hydridocarbyne). Methods for the preparation of poly(hydridocarbyne) are disclosed in Berrang, PCT Application No. PCT/CA2011/000134, titled “Method for Making Poly(hydridocarbyne)”.

Starting with unmixed reactants (110) for producing reticulated polymer foam having an average cell diameter of about 300 microns, chopped or milled fibers 600 microns to 1.5 millimeters long are added (111) to the unmixed reactants, and thoroughly mixed therein using, for example, mechanical stirring and/or sonification.

The doped reactants are then mixed (112) to allow foam formation and curing.

The cured HPOCF is then immersed (113) in an organic solution containing poly(hydridocarbyne). The organic solvent (i.e. acetone, chloroform, dichloromethane, etc.) is evaporated (114), leaving a coating of poly(hydridocarbyne) over all surfaces of the HPOCF.

The HPOCF is then heated (115) to burn off the polymer.

The poly(hydridocarbyne) construct is then heated (116) to approximately 1,000° C., preferably in an inert atmosphere, to convert it to diamond and diamond-like carbon, producing a final product that is a diamond or diamond-like carbon construct 117 that has substantially the same form as the fiber-entrained polymer HPOCF template.

In an alternate embodiment, the poly(hydridocarbyne) construct is converted to diamond and diamond-like carbon by immersing the construct in liquid ozone to remove the pendant hydrogen, producing a final product that is a diamond or diamond-like carbon construct that has substantially the same form as the fiber-entrained polymer HPOCF template.

It will be appreciated by those skilled in the art that the preferred and alternative embodiments have been described in some detail but that certain modifications may be practiced without departing from the principles of the invention, which are to be reasonably inferred from this disclosure as a whole, from the summaries provided herein, from the detailed description of the preferred and alternative embodiments and the claims.

What is claimed is:

1. A reticulated open-cell foam having cells defined by a skeletal structure of ligaments and further comprising a plurality of fibers distributed substantially throughout said foam and extending across and between said cells of said foam.

2. The foam of claim 1 wherein said ligaments are of a material selected from the group comprising a polymer, a metal, a metal alloy, a metal oxide, a carbon material, glass.

3. The foam of claim of claim 2 wherein said ligaments are of one or more materials selected from the group comprising polyurethane, polypropylene, polyethylene, polyester, polyether, acrylonitrile butadiene styrene, fluoropolymers, polyvinyl chloride, cellulose, latex, co-polymers, vinyl acetate.

4. The foam of claim of claim 2 wherein said ligaments are of one or more materials selected from the group comprising nickel, titanium, iron, aluminum, copper.

5. The foam of claim of claim 2 wherein said ligaments are of one or more materials selected from the group comprising nickel-titanium, iron-carbon, aluminum-copper-zinc-magnesium.

6. The foam of claim of claim 2 wherein said ligaments are of one or more materials selected from the group comprising titanium dioxide or aluminum oxide.

7. The foam of claim of claim 2 wherein said ligaments are of one or more allotropes of carbon.

8. The foam of claim 2 wherein said ligaments are of one or more materials selected from the group comprising glass, a glass doped with aluminum, sodium, lead and/or boron.

9. The foam of claim 1 wherein said fibers are made of a material selected from among the group of materials comprising a polymer, a metal, a metal alloy, a metal oxide, a carbon material, glass.

10. The foam of claim 1 wherein said fibers are made of a material selected from among the group of materials comprising nylon, polyacrylonitrile, polystyrene, polyamide, polyimide, PAN, PET, polycarbonate, polyurethane, polyvinyl esters.

11. The foam of claim 1 wherein said fibers are made of a material selected from among the group of materials comprising tin, zinc, aluminum, copper, nickel, iron, chromium, titanium or vanadium.

12. The foam of claim 1 wherein said fibers are made of a material selected from among the group of materials comprising nickel-titanium, iron-carbon, aluminum-copper-zinc-magnesium or any eutectic alloy.

13. The foam of claim 1 wherein said fibers are made of a material selected from among the group of materials comprising titanium dioxide or aluminum oxide.

14. The foam of claim 1 wherein said fibers are made of one or more allotropes of carbon.

15. The foam of claim 1 wherein said fibers are made of a material selected from among the group of materials comprising glass, a glass doped with sodium, lead, aluminum or boron.

16. The foam of claim 1 wherein the ratio of the average cross-sectional area of said fibers to the average cross-sectional area of said ligaments is less than 1.

17. The foam of claim 16 wherein said ratio is between 0.01 and 0.1.

18. The foam of claim 1 wherein the ratio of the average length of said fibers to the average diameter of said cells is at least 2:1.

19. The foam of claim 18 wherein said ratio is between 2:1 and 10:1.

20. The foam of claim 19 wherein said ratio is between 2:1 and 5:1.

21. The foam of claim 1 wherein the average length of said fibers is between 400 microns and 40 millimeters.

22. The foam of claim 1 wherein the ratio of the average cross-sectional area of the fibers to the average cross-sectional area of the ligands is less than 1.

23. The foam of claim 22 wherein said ratio is between 0.01 and 0.1.

24. The foam of claim 1 wherein said fibers form a fibrous web integrated into and across said skeletal structure of ligaments.

25. The foam of claim 24 wherein said fibrous web has effective pore sizes substantially between 50 nanometers and 2 millimeters.

26. The foam of claim 1, 24 or 25 wherein the concentration of said fibers in relation to said ligament material is between 0.5% and 85% [w/w or v/v].

27. The foam of claim 26 wherein said concentration is between 10% and 30%.

28. A method for making a reticulated open-cell foam having cells defined by a skeletal structure of ligaments and further comprising a plurality of fibers distributed substantially throughout said foam and extending across and between said cells of said foam comprising the steps of:
adding said fibers to foam reactants used to make said skeletal structure of ligaments; and,
mixing said reactants including said added fibers.

29. The method of claim 28 wherein said ligaments are made of a polymer.

30. The method of claim 28 wherein said ligaments are of polyurethane.

31. The method of claim 28, 29 or 30 wherein said reactants are selected from among the group comprising liquid isocyanate, a liquid blend of polyols, a catalyst.

32. The method of claim 28 wherein said fibers are made of a polymer.

33. The method of claim 32 wherein said polymer is selected from the group comprising nylon, polyacrylonitrile, polystyrene, polyamide, polyimide, PAN, PET, polycarbonate, polyurethane and polyvinyl esters, polyacrylonitrile (PAN).

34. The method of claim 28 wherein said fibers are of one or more metals.

35. The method of claim 28 wherein said fibers are of one or more materials selected from the group comprising tin, zinc, aluminum, copper, nickel, iron, chromium, titanium, vanadium.

36. The method of claim 28 wherein said fibers are of one or more metal alloys.

37. The method of claim 28 wherein said fibers are of one or more materials selected from the group comprising nickel-titanium, iron-carbon, aluminum-copper-zinc-magnesium, any eutectic alloy.

38. The method of claim 28 wherein said fibers are of one or more materials selected from the group comprising titanium dioxide and aluminum oxide.

39. The method of claim 28 wherein said fibers are of one or more allotropes of carbon.

40. The method of claim 28 wherein said fibers are of one or more materials selected from the group comprising glass, a glass doped with aluminum, sodium, lead and/or boron.

41. A method for making a reticulated open-cell foam having cells defined by a skeletal structure of polymer ligaments and further comprising a plurality of fibers distributed substantially throughout said foam and extending across and between said cells of said foam comprising the steps of:
providing a starting reticulated open-cell foam having cells defined by a skeletal structure of polymer ligaments;
soaking said starting foam in an organic solvent containing a dispersion of one or more fiber additives substantially made of fibers of a material selected from among the group comprising polymer, metal, metal oxide, carbon, glass, so as to expand the cell diameters of said primary foam;
allowing said solvent to cause said starting foam to expand such that the average expanded cell diameter is at least the average length of said fibers; and,
causing or allowing said solvent to evaporate and said starting foam to shrink so as to entrain and retain said fibers across and between said cells.

42. The method of claim 41 wherein said solvent includes chloroform.

43. Use of the reticulated foam of claim 3 as a binding template for the fabrication of a resulting reticulated foam construct composed substantially of a single non-polymer material.

44. The use of claim 43 wherein said resulting reticulated foam nominally comprises a primary reticulated open-cell skeletal structure of ligaments and a secondary structure of fiber-like elements extending across and through said primary skeletal structure.

45. The use of claim 44 wherein said secondary structure is integrally bound to said primary structure.

46. The use of claim 44 wherein said secondary structure comprises a web of said fiber-like elements, said web being integrally bound to said primary structure.

47. The use of claim 46 wherein said non-polymer material is selected from among the group comprising metal, metal alloy, metal oxide, carbon material, glass.

48. A method of making a reticulated foam construct composed substantially of a single non-polymer material and comprising a primary reticulated open-cell skeletal structure of ligaments and a secondary structure of fiber-like elements extending across and through said primary skeletal structure, comprising the steps of:
providing a starting reticulated foam comprising an open-cell skeletal structure of polymer ligaments and further comprising a plurality of fibers distributed substantially throughout said structure and extending across and between cells defined by said ligaments;
preparing a slurry comprising one or more materials selected from among the group comprising metal, metal alloy, metal oxide, carbon material, glass, silicon dioxide, silicon carbide, silicon nitride;
coating all surfaces of said starting foam with said slurry; and,
pyrolizing said polymer ligaments.

49. The method of claim 48 wherein said slurry materials are further selected from the group comprising nanopowder, nanoparticles, nanofibers.

50. The method of 48 further comprising the step of further heating to sinter said slurry materials.

51. The method of claim 48 wherein said starting foam has an average cell diameter of between 200 and 400 microns, and said fibers have an average length between 600 microns and 1.5 millimeters.

52. The method of claim 49 wherein said nanopowder, nanoparticles or nanofibers have diameters of between 10 and 1000 nanometers.

53. The method of claim 49 wherein said nanofibers have lengths of between 20 nanometers and 50 microns and diameters of between 10 nanometers and 20 microns.

54. The method of claim 49 wherein said nanopowder comprises hollow spheres.

55. The method of claim 48 wherein said slurry comprises a material selected from among the group comprising nickel, titanium, iron, aluminum, copper.

56. The method of claim 48 wherein said slurry comprises a material selected from among the group comprising nickel-titanium, titanium-aluminum-vanadium, iron-carbon, aluminum-zinc-copper-magnesium.

57. The method of claim 48 wherein said slurry comprises a material selected from among the group comprising titanium dioxide, aluminum oxide.

58. The method of claim 57 further comprising the step of converting said dioxide to a substantially pure metal.

59. The method of claim 56 wherein said material is nitinol.

60. The use of the product of the method of claim 59 in a medical implant.

61. The method of claim 48 wherein said slurry comprises a material selected from among the group comprising any allotrope of carbon.

62. The method of claim 48 wherein said slurry comprises a material selected from among the group comprising glass, glass doped with aluminum, sodium, lead and/or boron.

63. A method of making a reticulated foam construct composed substantially of a single non-polymer material and comprising a primary reticulated open-cell skeletal structure of ligaments and a secondary structure of fiber-like elements extending across and through said primary skeletal structure, comprising the steps of:
providing a starting reticulated foam comprising an open-cell skeletal structure of polymer ligaments and further comprising a plurality of fibers distributed substantially throughout said structure and extending across and between cells defined by said ligaments;
directly depositing a metal or metal alloy unto the surfaces of said starting foam;
pyrolizing said polymer ligaments; and,
sintering said metal or metal alloy.

64. The method of claim 63 wherein said step of directly depositing comprises electroless nickel plating.

65. The method of claim 63 wherein said step of directly depositing comprises decomposing nickel carbonyl onto said starting foam.

66. The method of claim 63 wherein said step of directly depositing comprises impregnating said starting foam with nickel sulphate.

67. The method of claim 63 wherein said step of directly depositing comprises impregnating said starting foam with a sulphate solution of copper, nickel or lead.

68. A method of making a reticulated foam construct composed substantially of a single non-polymer material and comprising a primary reticulated open-cell skeletal structure of ligaments and a secondary structure of fiber-like elements extending across and through said primary skeletal structure, comprising the steps of:
preparing a mixture of foam reactants designed to produce a reticulated open-cell skeletal structure of polymer ligaments, and a fiber additive, said fiber additive comprising chopped or milled fibers 600 microns to 1.5 millimeters long;
mixing said mixture;
adding to said mixed mixture a nanopowder, nanoparticles or nanofibers of a material selected from among the group comprising metal, metal alloy, metal oxide, carbon material, glass, silicon dioxide, silicon carbide, silicon nitride;
curing the resulting product; and,
heating said resulting product to burn off said polymer.

69. The method of claim 68 wherein said nanopowder or nanoparticles have diameters between 10 and 1000 nanometers.

70. The method of claim 68 wherein said nanofibers have lengths of between 20 nanometers and 50 microns and diameters of between 10 nanometers and 20 microns.

71. The method of claim 68 wherein said nanopowder comprises hollow spheres.

72. The method of claim 68 wherein said nanopowder, nanoparticles or nanofibers are supplied in a concentration of between 5% and 95% w/w or v/v.

73. The method of claim 68 wherein said nanopowder, nanoparticles or nanofibers are of carbon and have diameters between 10 and 1000 nanometers and further comprising the step of heating the resulting product to about 3000° C. to graphitize said carbon.

74. A method of making a reticulated foam construct composed substantially of carbon and comprising a primary reticulated open-cell skeletal structure of ligaments and a secondary structure of fiber-like elements extending across and through said primary skeletal structure, comprising the steps of:
providing a starting reticulated foam comprising an open-cell skeletal structure of polymer ligaments and further comprising a plurality of fibers distributed substantially throughout said structure and extending across and between cells defined by said ligaments;
impregnating and imidizing said starting foam with poly(amide acid);
pyrolyzing to remove said polymer; and,
heating to about 3000° C. to graphitize the carbon.

75. The method of claim 74 wherein said step of impregnating comprises impregnating with a thermosetting phenolic resin.

76. A method of making a reticulated foam construct composed substantially of a non-polymer and comprising a primary reticulated open-cell skeletal structure of ligaments and a secondary structure of fiber-like elements extending across and through said primary skeletal structure, comprising the steps of:
providing a starting reticulated foam comprising an open-cell skeletal structure of polymer ligaments and further comprising a plurality of fibers distributed substantially throughout said structure and extending across and between cells defined by said ligaments;
immersing said starting foam in an organic solution containing poly(hydridocarbyne) and a solvent;
evaporating said solvent to leave a coating of poly(hydridocarbyne) on said ligaments and fibers;
pyrolyzing to remove said polymer and fibers;
heating to about 1,000° C. to convert said poly(hydridocarbyne) to diamond or diamond-like carbon.

77. A method of making a reticulated foam construct composed substantially of a non-polymer and comprising a primary reticulated open-cell skeletal structure of ligaments and a secondary structure of fiber-like elements extending across and through said primary skeletal structure, comprising the steps of:
providing a starting reticulated foam comprising an open-cell skeletal structure of polymer ligaments and further comprising a plurality of fibers distributed substantially throughout said structure and extending across and between cells defined by said ligaments;
immersing said starting foam in an organic solution containing poly(hydridocarbyne) and a solvent;
evaporating said solvent to leave a coating of poly(hydridocarbyne) on said ligaments and fibers;
pyrolyzing to remove said polymer and fibers;
converting said poly(hydridocarbyne) to diamond by immersion in liquid ozone.

78. Use of the foam made according to the method of claim 28 or 41.

79. A reticulated foam construct composed substantially of a single non-polymer material and comprising a primary reticulated open-cell skeletal structure of ligaments, said ligaments defining cells, and a secondary structure of fiber-like elements distributed substantially throughout said primary structure, said fiber-like elements extending through and between adjacent cells.

80. The foam construct of claim 79 wherein said non-polymer material is carbon.

81. The foam construct of claim 79 wherein said non-polymer is a carbon or carbon-like material derived from poly(hydridocarbyne).

82. Use of the foam construct made according to the method of claim 48, 63, 68, 74, 76, 77 or 79.
